(19) United States
(12) Patent Application Publication
(10) Pub. No.: US 2026/0328642 A1
(43) Pub. Date: Oct. 22, 2026

(54) ACCELERATED TEST METHOD AND DEVICE FOR RELIABILITY AND ACCURACY RETENTIVITY OF MACHINE TOOL SWIVEL HEADS

(71) Applicants: DALIAN UNIVERSITY OF TECHNOLOGY, Dalian (CN); LONGCHENG LABORATORY OF INTELLIGENT MANUFACTURING, Changzhou (CN)

(72) Inventors: Kuo LIU, Dalian (CN); Yufei WEI, Dalian (CN); Jiapeng XING, Dalian (CN); Di ZHAO, Dalian (CN); Pengxiang GAO, Dalian (CN); Xingzhe WANG, Dalian (CN); Yongqing WANG, Dalian (CN)

(21) Appl. No.: 19/696,943

(22) Filed: Jun. 3, 2026

Related U.S. Application Data
(63) Continuation of application No. PCT/CN2025/129748, filed on Oct. 24, 2025.

(30) Foreign Application Priority Data
Dec. 10, 2024 (CN) 202411806907.7

(51) Int. Cl. G01M 7/02; G01M 13/00; G01M 99/00

(52) U.S. Cl. CPC G01M 7/027; G01M 13/00; G01M 99/007

(57) ABSTRACT

The present invention discloses an accelerated test method and device for reliability and accuracy retentivity of a swivel head. The test device comprises the swivel head, a vibration loading device installed below the swivel head, a follow-up static/dynamic force loading device installed above the vibration loading device, a lifting support device installed on the outer side of the follow-up static/dynamic force loading device, an operating platform installed on one side of the vibration loading device, a high-low temperature loading device slidably connected to the operating platform, and an electromagnetic loading device installed at the output end of the lifting support device. The method comprises installing and positioning the swivel head into the high-low temperature loading device; conducting a stress combined loading test of temperature, vibration, velocity, static/dynamic forces and electromagnetism on the tested swivel head; measuring and recording all precision degradation data.

### TECHNICAL FIELD

The present invention relates to the technical field of mechanical testing, in particular to an accelerated test method and device for accuracy retentivity and reliability of machine tool swivel heads.

### BACKGROUND

In the technological development in recent years, domestic swivel heads have possessed the functions of high-speed steady rotation, high-accuracy positioning, etc., possessed high initial accuracy, and approached the foreign advanced level. However, there are still significant gaps from foreign advanced machine tool enterprises in the accuracy retentivity and the reliability of the domestic swivel heads. The traditional on-site tracking test methods in service environments are too inefficient, and the tracking testing process often takes months or even years.

At home and abroad, relevant research is mainly carried out on the aspects of thermal characteristics and structural design optimization of the swivel heads, while there is few research on the aspects of the accuracy retentivity and the reliability. The research and analysis of the relevant tests for testing the accuracy retentivity and the reliability of the swivel heads reveal that: (1) at present, the technological research on the relevant tests for rotary tables, toolholder, etc. has been carried out, but there is still a lack of test methods and devices for the accuracy retentivity of the swivel heads; and (2) the existing test methods are all carried out under conventional stress, the influencing factors such as temperature, vibration and electromagnetism are not taken into account during loading, and a cycle for acquiring the accuracy degradation data and the failure data of the swivel heads is long.

At present, there is domestically still a lack of development of accelerated test methods and devices for accuracy retentivity and reliability of swivel heads. Therefore, there is an urgent need to invent an accelerated test method and device for accuracy retentivity and reliability of a swivel head, to achieve the rapid acquisition of accuracy retentivity and reliability levels of the swivel head in a short time.

### SUMMARY

The purpose of the present invention is to provide an accelerated test method and device for accuracy retentivity and reliability of a swivel head to solve the problems proposed in the above background.

To solve the above technical problem, the present invention provides the following technical solution: an accelerated test method for accuracy retentivity and reliability of a swivel head comprises the following steps:
step 1, installing and positioning the swivel head into the high-low temperature loading device, and adjusting the spatial height thereof to reach a preset position;
step 2, conducting a multi-stress loading test of temperature, vibration, speed, static/dynamic forces and electromagnetism on the tested swivel head;
step 3, measuring and recording all accuracy degradation data and failure data of the swivel head;
step 4, calculating all accuracy retaining levels and reliability levels of the swivel head, and evaluating the accuracy retentivity and the reliability of the swivel head objectively.

The present invention is further described: in the step 2, n stress level grades are set, where n≥3 and the loading time for each stress level is T; T is preferably 120 h; and the loading stress values at all stress levels are determined based on the temperature changes of the swivel head under service conditions, vibration signals transmitted by an entire machine tool, the maximum feed rate vmax of each rotating feed axis, the maximum spindle speed Vmax, the maximum feed resistance Fmax of spindle, and the maximum magnetic field intensity that a motor can withstand.

The present invention is further described: at each stress level in the step 2, each time a cycle of stress loading is performed on the swivel head, all accuracy degradation data of the swivel head and the failure data in the process of a loading test are measured and recorded.

The present invention is further described: each stress level grade comprises a temperature range, a vibration magnitude, feed rate of the rotating feed axis, spindle speed, a static/dynamic force amplitude, frequency, and a test grade of applied magnetic field intensity.

The temperature range is denoted as ΔTi; i is 1−n; i represents a corresponding stress level grade; when i is larger, a difference within the temperature range is larger; ΔTn is set as 0-40° C, and the temperature range ΔTi is determined within 0-40 °C.

The grade of the vibration magnitude and the test grade of the magnetic field intensity are both consistent with the stress level grade.

The feed rate of the rotating feed axis is set as θi·vmax, where vmax is a maximum feed rate, θi is a first value coefficient, and the value range of θi is 20%-70%; the spindle speed is set as § i·Vmax, where Vmax is a maximum spindle speed, § i is a second value coefficient, and the value range of § i is 10%-50%; the static/dynamic force amplitude is set as βi·Fmax, where Fmax is the maximum feed resistance of spindle, βi is a third value coefficient, and the value range of βi is 25%-75%; the frequency is set as αi·Vmax/60 Hz, where αi is a fourth value coefficient, and the value range of αi is 2.5%-7.5%;

wherein αi, § I, βi and θi will increase with the increase of the stress level grade i.

When N=3, 3 stress levels are as follows.

Stress level 1 is set as follows: the temperature range is ΔT1, the vibration magnitude is set as 50%, the feed rate of the rotating feed axis is set as 20% vmax, the spindle speed is set as 10% Vmax, the static/dynamic force amplitude is set as 25% of the maximum spindle feed resistance, the frequency is set as 2.5% Vmax/60 Hz, and a test grade 1 of magnetic field intensity is added.

Stress level 2 is set as follows: the temperature range is ΔT2, the vibration magnitude is set as 75%, the feed rate of the rotating feed axis is set as 50% vmax, the spindle speed is set as 30% Vmax, the static/dynamic force amplitude is set as 50% of the maximum spindle feed resistance, the frequency is set as 5% Vmax/60 Hz, and a test grade 2 of magnetic field intensity is added.

Stress level 3 is set as follows: the temperature range is ΔT3, the vibration magnitude is set as 100%, the feed rate of the rotating feed axis is set as 70% vmax, the spindle speed is set as 50% Vmax, the static/dynamic force amplitude is set as 75% of the maximum spindle feed resistance, the frequency is set as 7.5% Vmax/60 Hz, and a test grade 3 of magnetic field intensity is added.

The present invention is further described: the maximum feed rate vmax is preferably 160°/sec, the maximum spindle speed Vmax is preferably 24000 rpm, the maximum spindle feed resistance in a static state is preferably 2000N, and the maximum spindle feed resistance in a dynamic state is preferably 400 N; the magnetic field intensity that the motor can withstand is 1 A/m to 10 A/m; and the temperature ranges of the stress levels within 3 grades increase in sequence.

The present invention is further described: loading for 120 h is performed respectively at different stress levels:
\textcircled{1} vibration stress and temperature stress are applied simultaneously to the swivel head; and loading is performed for set time;
\textcircled{2} temperature stress, velocity stress and static force are applied simultaneously to the swivel head; and loading is performed for set time;
\textcircled{3} temperature stress and dynamic force are applied simultaneously to the swivel head; and loading is performed for set time;
\textcircled{4} velocity stress and electromagnetic stress are applied simultaneously to the swivel head; and loading is performed for set time;
\textcircled{5} the high-low temperature loading device is adjusted so that the swivel head reaches 20° C and is in a balanced state;
\textcircled{6} corresponding instrument devices are used for conducting various accuracy tests on the swivel head to acquire the degradation data of the swivel head; the failure data that occurs during the loading test of the swivel head is recorded, and failure positions are repaired in time;
\textcircled{7} steps \textcircled{1} to \textcircled{6} are repeated until the loading test at the current stress level is completed for a preset cycle, the stress level is adjusted, and the above loading test steps are repeated until the total loading time reaches the specified time.

The present invention is further described: the step 4 specifically comprises evaluating the accuracy retentivity level and the reliability level of the swivel head objectively through the following formulas by using all accuracy degradation data and failure data of the swivel head collected in the above step.

The accuracy retentivity is evaluated as:

$$G ( t ) = 1 - {\int }_{0}^{t} f ( t ) d t / M t ;$$

where t is degradation time, G(t) is a retaining ability function, ƒ(t) is an accuracy degradation function under conventional working conditions, and M is an accuracy failure threshold of the swivel head.

The present invention is further described: the reliability is evaluated as:

$$MTBF = \frac{{t}_{all} - {t}_{f}}{{n}_{f}} ;$$

MTBF is mean time between failures, tₐₗₗ is all test time, t_{f} is failure time, and n_{f} is the number of failure times.

Compared with the prior art, the present invention achieves the following beneficial effects: the present invention provides an accelerated test method for accuracy retentivity and reliability of a swivel head, completely elaborates the testing process and the evaluation methods for accuracy retentivity and reliability, and can acquire the long-term degradation accuracy and failure data of the swivel head in a short time, thereby significantly reducing the time cost.

### DESCRIPTION OF DRAWINGS

The drawings are used to provide further understanding for the present invention and constitute part of the description. The drawings are used to explain the present invention together with the embodiments of the present invention, and do not constitute a limitation to the present invention. In the drawings:

FIG. 1 is a flow chart of a test method of the present invention;

FIG. 2 is a schematic diagram of a test device of the present invention;

In the figures: 1. swivel head; 2. high-low temperature loading device; 3. vibration loading device; 4. follow-up static/dynamic force loading device; 5. lifting support device; 6. operating platform; 7. electromagnetic loading device.

### DETAILED DESCRIPTION

The technical solution of the present invention is further described below in detail in a non-restrictive manner in combination with preferred embodiments and the drawings. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

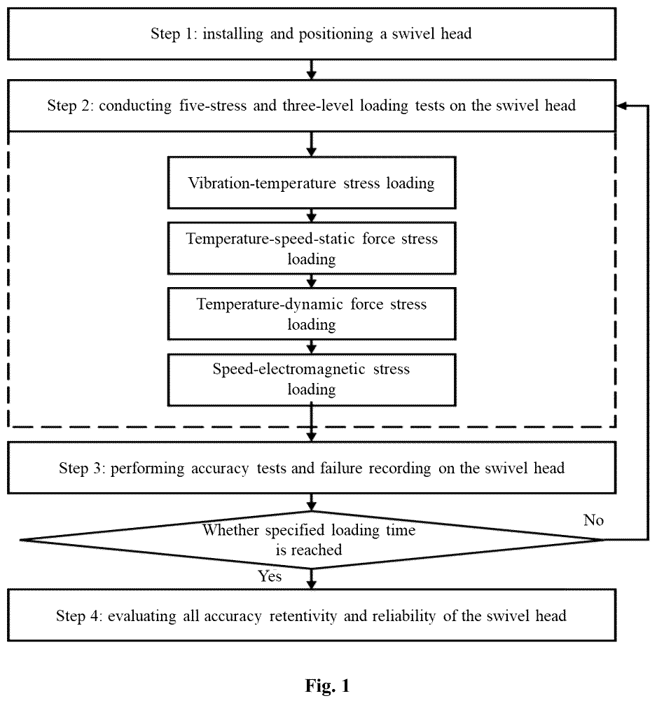

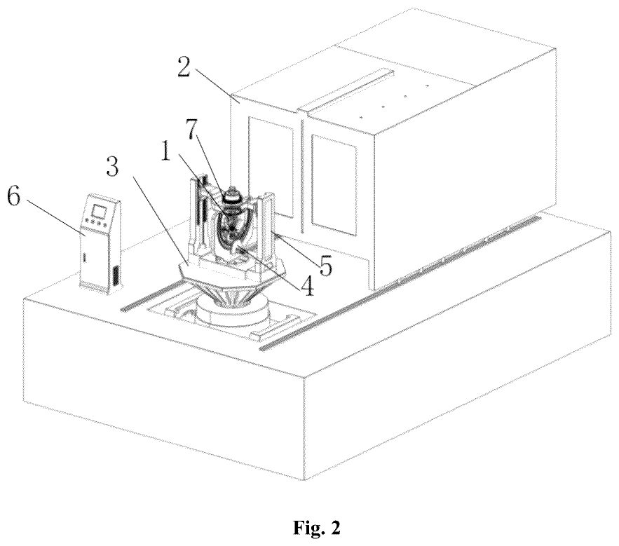

Referring to FIGS. 1-2, the present invention provides a technical solution: an accelerated test method for accuracy retentivity and reliability of a swivel head is implemented based on an accelerated test device for accuracy retentivity and reliability of the swivel head. The test device comprises the swivel head 1, and the swivel head 1 is connected with a simulated toolholder.

A vibration loading device 3 is installed below the swivel head 1, is used for simulating different degrees of vibration under different conditions and is provided with multiple vibration magnitudes.

A follow-up static/dynamic force loading device 4 is installed above the vibration loading device 3 for performing combined dynamic and static loading on the swivel head 1 to more comprehensively test the performance of materials or structures under different working conditions. The lower end of the simulated toolholder is connected with the operation output end of the follow-up static/dynamic force loading device 4, and a force sensor is arranged at the connection for pressure data transmission. In addition, the follow-up static/dynamic force loading device 4 is configured as a triaxial force loading structure, the triaxial force loading structure is used for applying three-directional static/dynamic forces to the swivel head, and the triaxial force loading structure adopts a rack and pinion structure for performing circular motion.

A lifting support device 5 is installed on the outer side of the follow-up static/dynamic force loading device 4, and the lifting support device 5 is connected with the swivel head 1 to achieve the effect of adjusting the height of the swivel head 1.

The output end of the lifting support device 5 connected with the swivel head 1 is equipped with an electromagnetic loading device 7 for providing electromagnetic stress of different grades.

An operating platform 6 is installed on one side of the vibration loading device 3 to achieve the control and data reception for each device.

The operating platform 6 is slidably connected with a high-low temperature loading device 2 for testing the accuracy retentivity and the reliability of the swivel head 1 under different temperature conditions.

Therefore, the above test method comprises the following steps:
Step 1, installing and positioning the swivel head 1 into the high-low temperature loading device 2, and adjusting the spatial height thereof to reach a preset position;
Specifically, the swivel head 1 is installed into the high-low temperature loading device 2 and fixed to the lifting support device 5, and the lifting support device 5 is fixed to a table top of the vibration loading device 3 through bolts.

According to the three-dimensional size of the swivel head 1, the lifting support device 5 moves up and down to drive the swivel head 1 to move into the working area of the follow-up static/dynamic force loading device 4.
Step 2, conducting a combined stress loading test of temperature, vibration, speed, static/dynamic forces and electromagnetism on the tested swivel head 1;

Specifically, the loading is as follows: vibration and temperature stress loading; temperature, vibration and static force stress loading; temperature and dynamic force stress loading; and speed and electromagnetic stress loading.
Step 3, measuring and recording all accuracy degradation data and failure data of the swivel head;
3 stress levels are set, and stress loading tests under multiple combinations are performed at the corresponding stress levels; and the loading time for the load at each level is 120 h.

At each stress level, each time a cycle of stress loading is performed on the swivel head, all accuracy degradation data of the swivel head and the failure data in the process of the loading test are measured and recorded.
Step 4, calculating all accuracy retaining levels and reliability levels of the swivel head, and evaluating the accuracy retentivity and the reliability of the swivel head objectively.

Further, 3 stress levels are set as an example.

Stress level 1 is set as follows: the temperature range is 15-25° C, the vibration magnitude is set as level 1, the feed rate of the rotating feed axis is set as 32°/sec, the spindle speed is set as 2400 rpm, the static/dynamic force amplitude is set as 500/100 N, the frequency is set as 10 Hz, and the magnitude of the applied magnetic field intensity is 1 A/m;

Stress level 2 is set as follows: the temperature range is 10-30° C, the vibration magnitude is set as level 2, the feed rate of the rotating feed axis is set as 80°/sec, the spindle speed is set as 7200 rpm, the static/dynamic force amplitude is set as 1000/200 N, the frequency is set as 20 Hz, and the magnitude of the applied magnetic field intensity is 3 A/m;

Stress level 3 is set as follows: the temperature range is 0-40° C, the vibration magnitude is set as level 3, the feed rate of the rotating feed axis is set as 112°/sec, the spindle speed is set as 12000 rpm, the static/dynamic force amplitude is set as 1500/300 N, the frequency is set as 30 Hz, and the magnitude of the applied magnetic field intensity is 10 A/m.

Loading for 120 h is performed at different stress levels, exemplarily:
\textcircled{1} vibration stress and temperature stress are applied simultaneously to the swivel head; the loading time is 4 h;
\textcircled{2} temperature stress, velocity stress and static force are applied simultaneously to the swivel head; the loading time is 6 h;
\textcircled{3} temperature stress and dynamic force are applied simultaneously to the swivel head; the loading time is 6 h;
\textcircled{4} velocity stress and electromagnetic stress are applied simultaneously to the swivel head; the loading time is 2 h;
\textcircled{5} the high-low temperature loading device is adjusted so that the swivel head reaches 20° C and is in a balanced state;
\textcircled{6} instrument devices such as laser interferometers and spindle error analyzers are used for conducting various accuracy tests on the swivel head to acquire the degradation data, such as positioning accuracy and repeating accuracy of the rotating feed axis and spindle rotation accuracy, of the swivel head; the failure data, such as failure type and failure time, that occurs during the loading test of the swivel head is recorded, and failure positions are repaired in time;
\textcircled{7} steps \textcircled{1} to \textcircled{6} are repeated until the loading test at the current stress level is completed for 5 cycles, the stress level is adjusted, and the above loading test steps are repeated until the total loading time reaches the specified time.

The step 4 specifically comprises evaluating the accuracy retentivity level and the reliability level of the swivel head objectively through the following formulas by using all accuracy degradation data and failure data of the swivel head collected in the above step.

The accuracy retentivity is evaluated as:

$$G ( t ) = 1 - {\int }_{0}^{t} f ( t ) d t / M t ;$$

where t is degradation time, G(t) is a retaining ability function, ƒ(t) is an accuracy degradation function under conventional working conditions, and M is an accuracy failure threshold of the swivel head;
The reliability is evaluated as:

$$MTBF = \frac{{t}_{all} - {t}_{f}}{{n}_{f}} ;$$

MTBF is mean time between failures, tₐₗₗ is all test time, t_{f} is failure time, and n_{f} is the number of failure times.

Finally, it should be noted that the above embodiments are only used for describing the technical solution of the present invention rather than limitation. Although the present invention is described in detail by referring to the above embodiments, those ordinary skilled in the art should understand that: the amendments to the technical solution recorded in each of the above embodiments or the equivalent replacements for part of the technical features therein do not enable the essence of the corresponding technical solution to depart from the spirit and scope of the technical solutions of various embodiments of the present invention.

1. An accelerated test method for accuracy retentivity and reliability of swivel heads, implemented based on an accelerated test device for accuracy retentivity and reliability of the swivel head, wherein the test device comprises the swivel head, a vibration loading device installed below the swivel head, a follow-up static/dynamic force loading device installed above the vibration loading device, a lifting support device installed on the outer side of the follow-up static/dynamic force loading device, an operating platform installed on one side of the vibration loading device, a high-low temperature loading device slidably connected to the operating platform, and an electromagnetic stress loading device installed at the output end of the lifting support device, and the swivel head is connected with a simulated toolholder;
wherein the method comprises the following steps:
step 1, installing and positioning the swivel head into the high-low temperature loading device, and adjusting the spatial height thereof to reach a preset position;
step 2, conducting a combined stress loading test of temperature, vibration, speed, static/dynamic forces and electromagnetism on the tested swivel head, wherein in the step 2, n stress level grades are set, and each stress level grade comprises a temperature range, a vibration magnitude, feed rate of a rotating feed axis, spindle speed, a static/dynamic force amplitude, frequency, and a test grade of applied magnetic field intensity;
the feed rate of the rotating feed axis is set as θi·vmax, where vmax is a maximum feed rate, θi is a first value coefficient, and the value range of θi is 20%-70%; the spindle speed is set as § i·Vmax, where Vmax is a maximum spindle speed, § i is a second value coefficient, and the value range of § i is 10%-50%; the static/dynamic force amplitude is set as βi·Fmax, where Fmax is a maximum spindle feed resistance, βi is a third value coefficient, and the value range of βi is 25%-75%; the frequency is set as αi·Vmax/60 Hz, where αi is a fourth value coefficient, and the value range of αi is 2.5%-7.5%;
step 3, measuring and recording all accuracy degradation data and failure data of the swivel head;
step 4, calculating all accuracy retaining levels and reliability levels of the swivel head, and evaluating the accuracy retentivity and the reliability of the swivel head objectively, evaluation formulas of the accuracy retentivity and the reliability in the step 4 are as follows:
the evaluation formula of the accuracy retentivity is:
$$G ( t ) = 1 - {\int }_{0}^{t} f ( t ) d t / M t ;$$
where t is degradation time, G(t) is a retaining ability function, ƒ(t) is an accuracy degradation function under conventional working conditions, and M is an accuracy failure threshold of the swivel head;
the evaluation formula of the reliability is:
$$MTBF = \frac{{t}_{all} - {t}_{f}}{{n}_{f}} ;$$
MTBF is mean time between failures, tₐₗₗ is all test time, t_{f} is failure time, and n_{f} is the number of failure times.

2. The accelerated test method for accuracy retentivity and reliability of the swivel head according to claim 1, wherein n≥3, and the loading time for loads at each stress level is T.

3. The accelerated test method for accuracy retentivity and reliability of the swivel head according to claim 1, wherein the temperature range is denoted as ΔTi; i is 1−n; i represents a corresponding stress level grade; when i is larger, a difference within the temperature range is larger;
ΔTn is set as 0-40° C, and the temperature range ΔTi is determined within 0-40 °C.

4. The accelerated test method for accuracy retentivity and reliability of the swivel head according to claim 1, wherein the grade of the vibration magnitude and the test grade of the magnetic field intensity are both consistent with the stress level grade.

5. The accelerated test method for accuracy retentivity and reliability of the swivel head according to claim 1, wherein θi increases with the increase of the stress level grade i.

6. The accelerated test method for accuracy retentivity and reliability of the swivel head according to claim 1, wherein § i increases with the increase of the stress level grade i.

7. The accelerated test method for accuracy retentivity and reliability of the swivel head according to claim 1, wherein βi increases with the increase of the stress level grade i.

8. The accelerated test method for accuracy retentivity and reliability of the swivel head according to claim 1, wherein ai increases with the increase of the stress level grade i.
